(19) United States
(12) Patent Application Publication
(10) Pub. No.: US 2026/0164241 A1
(43) Pub. Date: Jun. 11, 2026

(54) ENDPOINT DEVICE INTRUSION DETECTION USING WIRELESS ENVIRONMENT DATA

(71) Applicant: AT&T Intellectual Property I, L.P., Atlanta, GA (US)

(72) Inventors: Yupeng Jia, South Pasadena, CA (US); Rashmi Palamadai, Naperville, IL (US)

(21) Appl. No.: 18/977,897

(22) Filed: Dec. 11, 2024

(51) Int. Cl. H04W 12/08; H04W 4/029

(52) U.S. Cl. CPC H04W 12/08; H04W 4/029

(57) ABSTRACT

A processing system may obtain first wireless environment data associated with at least one wireless network access point at a premises and may detect that the first wireless environment data includes first wireless signal data of a first non-approved endpoint device. The processing system may further track a movement of the first non-approved endpoint device in accordance with the first wireless signal data of the first non-approved endpoint device in the first wireless environment data and may detect, via the tracking of the movement of the first non-approved endpoint device in accordance with the first wireless signal data, that the first non-approved endpoint device is within an alert perimeter associated with the premises. The processing system may then generate a first alert in response to the detecting that the first non-approved endpoint device is within the alert perimeter associated with the premises.

The present disclosure relates generally to wireless communication network operations, and more particularly to methods, computer-readable media, and apparatuses for detecting that a non-approved endpoint device is within an alert perimeter associated with a premises via tracking of a movement in accordance with wireless signal data of the non-approved endpoint device contained in wireless environment data associated with at least one wireless network access point at the premises.

### BACKGROUND

A building management system (BMS) may monitor one or more different physical parameters relating to a building environment, including for example: temperature, humidity, atmospheric pressure, light level, sound level, and so forth. A BMS may include a number of sensors throughout a room, a building, or a group of several buildings. The sensors may also be connected to and managed by an aggregation panel that receives data generated by the sensors. A building management system may also include premises security systems, which may further include sensors to detect openings of doors and/or windows, doorbell cameras and/or other cameras deployed to capture video/images from different vantages, and so forth.

### SUMMARY

In one example, the present disclosure describes a method, non-transitory computer-readable medium, and apparatus for detecting that a non-approved endpoint device is within an alert perimeter associated with a premises via tracking of a movement in accordance with wireless signal data of the non-approved endpoint device contained in wireless environment data associated with at least one wireless network access point at the premises. For instance, a processing system including at least one processor may obtain first wireless environment data associated with at least one wireless network access point at a premises and may detect that the first wireless environment data includes first wireless signal data of a first non-approved endpoint device. The processing system may further track a movement of the first non-approved endpoint device in accordance with the first wireless signal data of the first non-approved endpoint device in the first wireless environment data and may detect, via the tracking of the movement of the first non-approved endpoint device in accordance with the first wireless signal data, that the first non-approved endpoint device is within an alert perimeter associated with the premises. The processing system may then generate a first alert in response to the detecting that the first non-approved endpoint device is within the alert perimeter associated with the premises.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates a flowchart of an example method for detecting that a non-approved endpoint device is within an alert perimeter associated with a premises via tracking of a movement in accordance with wireless signal data of the non-approved endpoint device contained in wireless environment data associated with at least one wireless network access point at the premises; and

FIG. 3 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure include methods, non-transitory computer-readable media, and apparatuses for detecting that a non-approved endpoint device is within an alert perimeter associated with a premises via tracking of a movement in accordance with wireless signal data of the non-approved endpoint device contained in wireless environment data associated with at least one wireless network access point at the premises. For instance, examples of the present disclosure provide a local network-based and/or carrier network-based service to identify all devices that attach to and/or that are detectable in the vicinity of a local wireless network using electro-magnetic detection and/or through electronic handshake, such as for establishing a connection to a wireless access point. To illustrate, in one example, the present disclosure may identify wireless communication devices within a geo-fenced zone, or perimeter, defined by the user and/or defined based on the capabilities of the wireless access point(s) associated with the local wireless network. In one example, the present disclosure may include one or more artificial intelligence (AI)/machine learning (ML) components to learn and predict benign visiting devices versus devices that may be associated with a threat, e.g., to person or property, and/or with respect to the network/wireless communication-related activities, such as passive Wi-Fi sniffing, or the like.

In one example, the present disclosure may record and report unusual/suspect devices and/or device behaviors. For instance, electronic signatures may be recorded for devices and behaviors. In addition, from the electronic signatures, the present disclosure may apply pattern recognition, e.g., AI/ML-based and/or rule-based, to identify electronic devices of individuals who may be a threat, or who are otherwise unauthorized and/or unexpected to be at a premises, and to further communicate a threat level to a user (e.g., a property owner, an occupant, a property manager, etc.) and/or to a network operator. In one example, a user may select and configure customized alerts, e.g., sound, verbiage, visual, etc., either via devices on the premises (e.g., smart-building/internet-of-thing (IOT) device) and/or at a user endpoint device, such as the user’s mobile smartphone. In one example, the present disclosure may distinguish between strangers, or unidentified/unknown electronic devices versus those of family members, tenants, guests, etc. In addition, in one example, the present disclosure may indicate when it is a known individual versus an unknown individual who may be present in connection with the opening or ringing of a door, the opening of a window, etc.

In one example, the present disclosure may specifically determine the estimated locations of electronic devices attached to the wireless network and/or detectable to the wireless network. In one example, the present disclosure may also present a map of the locations of these electronic device, e.g., indicating the device locations within a house, vehicle, or other secure spaces, in a yard or outside a building, etc. within a defined geo-fenced zone, e.g., within a perimeter. In one example, the present disclosure may track behaviors of these devices, particularly the movement thereof for determining whether devices are known/unknown, threat/non-threat, etc. In addition, in one example, these movements may also be plotted on a map illustrating heat zones showing where devices that are detected to be lingering in a particular area, e.g., on a display screen of a user endpoint device of the property owner, manager, occupant, etc.

In one example, known electronic devices within the ecosystem may provide device electronic signatures, e.g., indicating the upper and lower limits of frequency ranges that may be used/supported, the protocols in use (e.g., 3^{rd} Generation Partnership Project (3GPP) cellular network frequency ranges, Institute of Electrical and Electronic Engineers (IEEE) 802.11 (Wi-FI) frequency ranges, IEEE 802.15 (e.g., Bluetooth, etc.) frequency ranges, and so forth). Using these electronic signatures and/or device behavioral fingerprinting, peer devices and/or wireless access points may detect like devices (e.g., of a same device type, make, model, etc.) within range, to enhance the ability to better discern certain types of devices. Likewise, peer devices and/or other wireless networks may share knowledge of device signatures to learn from each other, e.g., to determine which devices are “friendly” and which may pose a “threat.” For example, wireless access points, e.g., wireless routers, and other wireless communication devices may detect electromagnetic threats, where in one example, known and trusted devices may communicate with each other to be alerted of the detected intruder devices. Thus, examples of the present disclosure my provide enhanced security using existing network and customer profile features to identify all devices that access a local wireless network using electro-magnetic detection (and/or) via electronic handshakes. In addition, user may work directly with a carrier communication network to proactively identify threats (as well as friendly devices), to further enhance premises and/or network security.

In one example, the present disclosure may include a smart-premises (e.g., a smart-home) manager application in operation on one or more user endpoint devices that may be in communication with consumer devices in a local wireless network of the premises, such as one or more wireless router/wireless access points, IoT/sensor devices, etc. In one example, these devices may be managed via a building management system (BMS). However, in another example, such devices may be in communication with each other via the local network (e.g., wireless local network and/or a wired portion of a same local network) and/or via one or more carrier communication networks. In one example, via the smart-premises manager application, a user may define a secure space and geofencing requirements for all devices (e.g., a premises and a secure perimeter thereof). In one example, the perimeter may alternatively or additionally be set based upon the capabilities of one or more wireless access points, e.g., the sensing range and/or the range within which devices may attach to the wireless network with a likelihood of obtaining greater than a threshold received signal strength and/or over a minimum noise floor, etc.

In one example, the user (e.g., a homeowner, property manager, tenant, etc.) may monitor the premises and electronic devices therein, e.g., at a home. It should be noted that in other examples, a “secure space” may also be defined for an enterprise premises (e.g., an office, a campus, etc.), for a connected car, and so forth. In one example, when unknown devices are found to be within a certain distance of the secure space (e.g., a device is detectable within Wi-Fi range and/or within range of peer devices connected to the Wi-Fi network that may assist in detected unknown devices), the present disclosure may then commence tracking of these devices. It should be noted that devices not within the perimeter/geofence may still be detected, and tracking/tracing may begin. However, these devices may only be considered as potential threats/potential unknown devices while remaining outside the perimeter. As noted above, device types may be determined in some cases using electronic signatures of known devices of a same type. This can be used to improve threat detection/categorization for new devices approaching the premises/perimeter thereof.

To further illustrate, new detected devices may be categorized as “new” until user feedback is received on whether or not the device (and/or the individual associated with the device) is a threat. In one example, friendly/non-threat devices may be identified and accepted by the user via the smart-premises manager application. For instance, the user may bring home a new device, which may be detected via one or more wireless access points/wireless routers of the home wireless network. An alert may be sent to the user on the user’s own electronic device, where the user can choose to “add/approve” the device to the ecosystem (or to similarly deny or ignore). Any device not approved is deemed to be a potential threat. In addition, in one example, devices that were “temporarily approved” may re-appear at a different time than may be unexpected and/or after an expiration of temporary approval, and may similarly be categorized as a threat/potential-threat.

Likewise, devices that were detected “lurking” on the periphery (e.g., outside the perimeter/geofence, but within wireless electronic detection range) and that move later within the perimeter may be escalated to a “threat” category. In one example, a user may see a list and/or a map of devices that are detected and their respective statuses/categorization. Such a list and/or map may include devices that are still outside the perimeter. In other words, a user may access information about such devices, even if such devices have not yet entered the perimeter so as to cause an alert. However, when such devices may enter the perimeter and do not have a prior status of “approved” or the like, the present disclosure may generate an alert to the user. The user can then choose to “approve,” “deny,” “ignore,” or “continue to monitor,” the detected devices.

For instance, the present disclosure may use AI/ML and device behavior monitoring, particularly location/movement tracking, to provide guidance/recommendations to the user regarding the likely threat levels and categorizations of different devices. For instance, when initiating an alert to the user, the present disclosure may indicate a recommended categorization. In one example, this may include a confidence score, a threat score, or the like, which may comprise an output of an AI/ML process in response to an input comprising behavioral data and/or electronic signature data of an unknown device that is being tracked. In one example, smart home/smart building devices may collaborate with other systems, such as neighbors’ security systems, neighborhood alert systems, or the like. In one example, the present disclosure may use machine learning and/or rule-based thresholding to set a “sensitivity” for alerts received from the neighbors’ systems (e.g., an expected delivery for one house may go to the wrong house, where the delivery service may erroneously be considered a “threat”). Similarly, AI/ML may be used to change the sensitivity (or to turn off monitoring entirely) during Halloween or similar holidays, during parties, or the like.

It should be noted that while examples of the present disclosure primarily address premises and personal security, aspects of device tracking and behavior monitoring may include recording of actual attempts to connect to the wireless network and/or usage of the wireless network (e.g., if an unknown device attaches to an open Wi-Fi network, for example). As such, if hacking, network snooping, or other malicious activities are detected, the user and/or the carrier communication network may be further alerted regarding such conditions. This may additionally include behavioral tracking data that may be recorded with respect to the unknown/threat device, such as when it was first detected, when it entered the perimeter, a heatmap of locations where the device spent the most time, a time when it attached to the network, the protocols used, the transmit power and/or frequency profile used, and so forth.

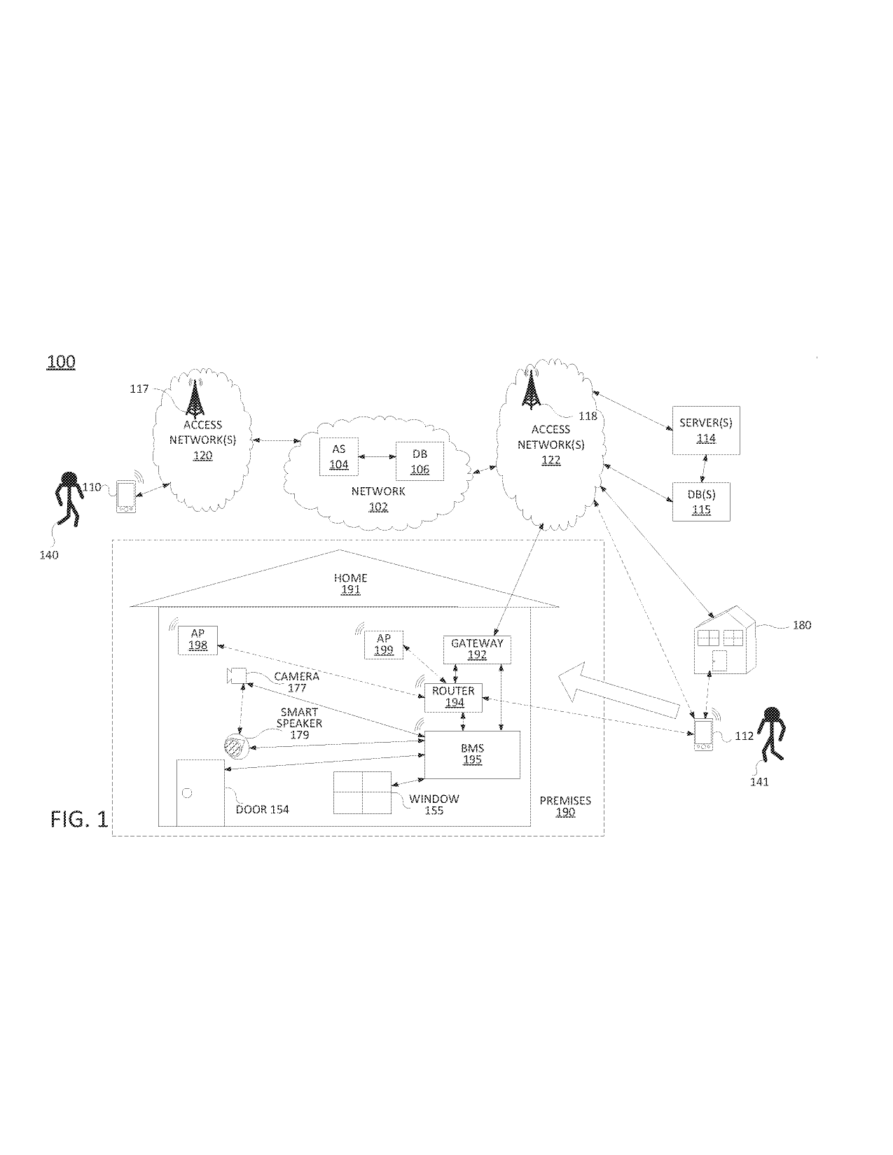

Examples of the present disclosure may be used in several illustrative scenarios. For instance, in one example, an intruder may enter a property, where even though the intruder’s smart phone may not connect to the network, it may be detected and an electronic record of its activity may be recorded. In addition, alerts may be transmitted to a user’s endpoint device and/or to the carrier communication network, additional alarm and security systems may be engaged, e.g., to present visible and/or audible alerts on the property itself, and so forth. In another example, a stranger may place a tracking device in or on a user’s network-connected vehicle, e.g., a protected premises having a defined perimeter. The vehicle may comprise a Wi-Fi hotspot that can identify other devices attached to the network or in the vicinity of the network, e.g., devices that remain within the perimeter over extended periods of time, such as hours, a day, or a few days, to distinguish from devices in nearby vehicles that may be moving in the same traffic. Similar to the above examples, the user (e.g., a vehicle owner, operator, etc.) may be alerted via the vehicle system components, such as a dashboard display, cabin speakers, etc., or via an endpoint device of the user. In one example, the vehicle’s on-board computing system, or on-board unit (OBU) may detect that the user is not present, and that the vehicle may therefore be stolen. If the vehicle is a smart car, it may detect a threat/non-owner and may pull over to a safe spot before shutting down and sending an alert, e.g., to the user, to law enforcement, etc. In one example, the present disclosure may provide different levels of location accuracy/granularity, such as an electronic device being detected to be within a purse, within a suitcase, within a car, etc. and/or a unknown individual/endpoint device being detected to be within a bedroom, a basement, a garage, on the first floor, on the second floor, and so forth. In one example, the present disclosure may further include manufacturer profiling of devices and/or device types and sharing of electronic signatures/profiles of such devices and/or device types for use in wireless sensing of devices and/or device types for providing premises security. These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a communication network of a communication service provider, e.g., a carrier network). The network 102 may be in communication with one or more access networks 120 and 122, and the Internet (not shown). In one example, network 102 may combine core network components of a cellular network with components of a triple-play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, 3^{rd} party networks, and the like. For example, the operator of network 102 may provide a broadband Internet access service, or any other types of telecommunication service to subscribers via access networks 120 and 122. Some of access networks 120 and 122 may comprise a cellular radio access network (RAN) in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In one example, the access networks 120 and 122 may comprise different types of access networks, may comprise the same type of access network, or some access networks may be the same type of access network and other may be different types of access networks. In one example, the network 102 may be operated by a communication network service provider. The network 102 and the access networks 120 and 122 may be operated by different service providers, the same service provider or a combination thereof.

In one example, the access networks 120 may be in communication with one or more devices, e.g., device 110. Similarly, access networks 122 may be in communication with one or more devices, e.g., device 112, servers 114, DB(s) 115, gateway 192, etc. Access networks 120 and 122 may transmit and receive communications between devices 110 and 112, server(s) 114, gateway 192, application server (AS) 104 and/or other components of network 102, devices reachable via the Internet in general, and so forth. In one example, each of the devices 110 and 112 may comprise any single device or combination of devices that may comprise an endpoint device, e.g., a client device. For example, the devices 110 and 112 may each comprise a mobile device, a cellular smart phone, a laptop, a tablet computer, a desktop computer, a wearable computing device (e.g., a smart watch, a smart pair of eyeglasses, etc.), an application server, a bank or cluster of such devices, or the like.

In one example, device 110 may be associated with a user 140 (e.g., an owner or manager of premises 190, or the like) and device 112 may be associated with another user 141, e.g., an unknown individual, who may be a potential threat, or who may be friendly, or benign. In one example, device 110 may have an application installed thereon for managing the premises 190, such as for receiving alerts/notifications of intrusion detection at premises 190 and/or home 191, providing instructions regarding classification of detected potential threats, receiving notifications of network-connected electronic device actions (e.g., activation of camera recording), transmission of notification to a public safety answering point (PSAP), etc. In one example, either or both of the devices 110 or 112 may include one or more radio frequency (RF) transceivers (as well as antenna(s), and/or other components) for cellular communications and/or for non-cellular wireless communications, such as for IEEE 802.11 based communications, IEEE 802.15 based communications, and so forth.

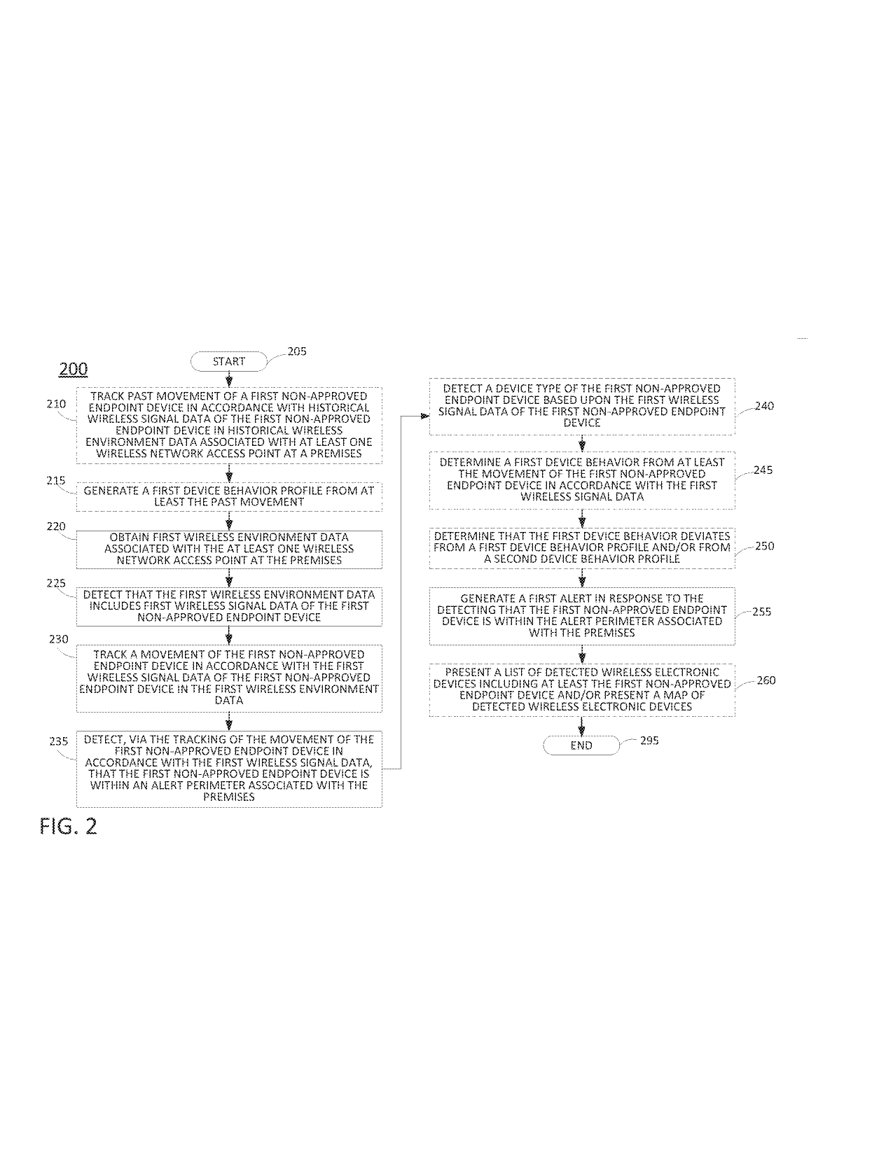

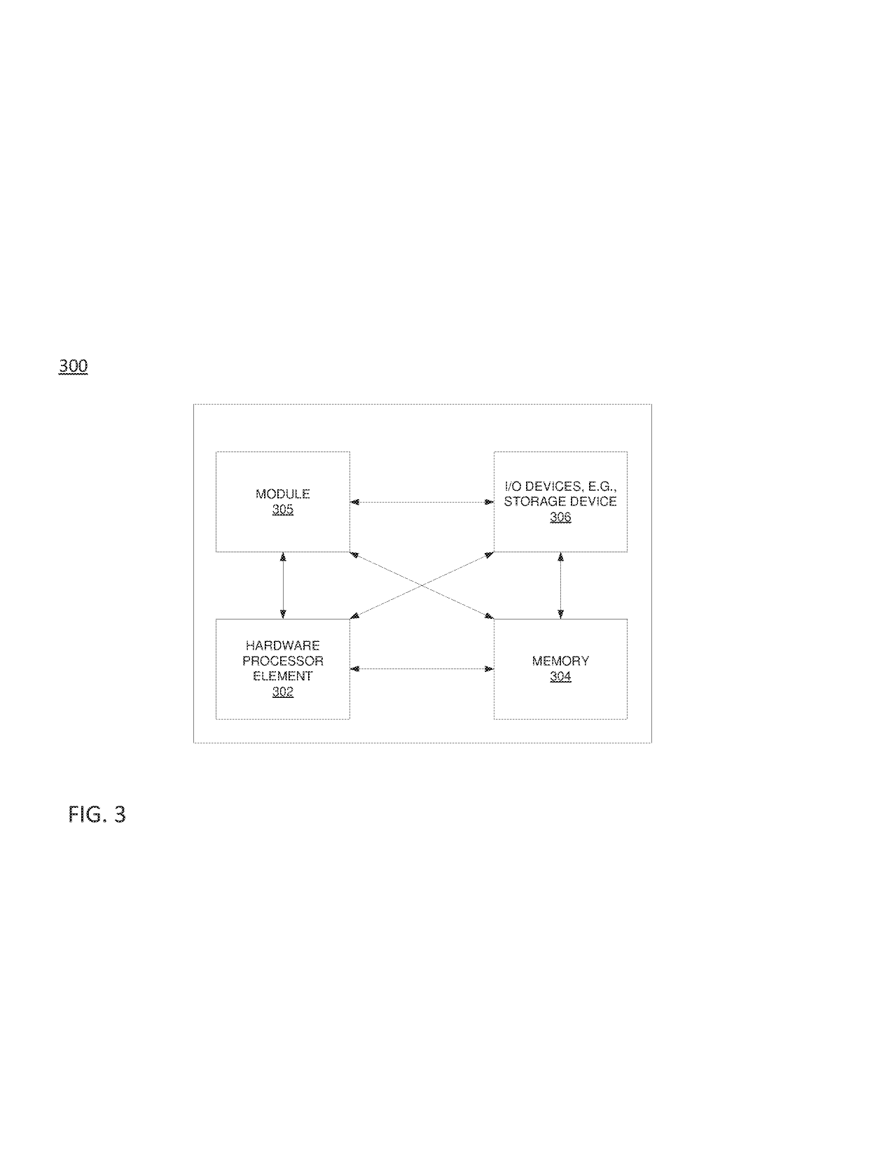

Similarly, server(s) 114 may each comprise a computing system or server, such as computing system 300 depicted in FIG. 3, and may be configured to provide one or more operations or functions in connection with examples of the present disclosure for detecting that a non-approved endpoint device is within an alert perimeter associated with a premises via tracking of a movement in accordance with wireless signal data of the non-approved endpoint device contained in wireless environment data associated with at least one wireless network access point at the premises, e.g., as described in connection with FIG. 2. For instance, server(s) 114 may provide a premises monitoring and management service (e.g., a “premises monitoring and management system”) in accordance with the present disclosure. In one example, database(s) 115 may represent one or more centralized or distributed file systems, e.g., a Hadoop® Distributed File System (HDFS^{TM}), or the like. Server(s) 114 may receive and store information in database(s) 115 relating to different users, such as user 140, different endpoint devices, and/or different premises, such as known (non-threat) network-connected electronic devices (including network-connected sensor devices), electronic devices that are unknown/potential threats, the locations and/or movements of these electronic devices, the electromagnetic signatures of such devices and/or classes of such devices, and so forth. In one example, server(s) 114 may establish communications with gateway 192 and/or devices within premises 190 periodically or on another basis to obtain and update all or a subset of the information maintained in database(s) 115 relating to the premises 190.

In one example, AS 104 may comprise a network-based server (or servers) providing a premises monitoring and management service (e.g., a “premises monitoring and management system”). In this regard, AS 104 may comprise the same or similar components as server(s) 114 and may provide the same or similar functions, or at least a portion thereof. For instance, an operator of network 102 may provide a premises monitoring and management service via AS 104 in accordance with the present disclosure (e.g., in addition to communication services such as video/television, phone, internet access, etc., as described above). Accordingly, DB(s) 106 may be the same as or similar to DB(s) 115 and may store the same or similar information. Thus, although the following examples are described primarily in connection with server(s) 114, it should be understood that the descriptions may equally apply to AS 104.

In one example, premises 190 may include a gateway 192 (e.g., a home gateway, an optical networking unit (ONU)/optical networking terminal (ONT), or the like), which receives data/communications associated with different types of media, e.g., television, phone, and Internet, and separates these communications for the appropriate devices. Gateway 192 may similarly receive and forward outbound communications from devices at premises 190. In one example, television data is forwarded to set-top boxes (STBs)/digital video recorders (DVRs) to be decoded, recorded, and/or forwarded to television(s) for presentation. In addition, telephone data is sent to and received from one or more telephones. It should be noted that for ease of illustration, STBs/DVRs, televisions, and telephones are omitted from FIG. 1. Similarly, Internet communications are sent to and received from router 194, which may be capable of both wired and/or wireless communication. In turn, router 194 may receive data from and send data to the appropriate devices, e.g., building management system (BMS) 195, camera 177 (e.g., a “smart” camera), smart speaker 179, door 154 (e.g., an electronically-controlled door), window 155 (e.g., a sensor-equipped window that may indicate the status of the window 155 as being opened or closed), and so forth.

In one example, router 194 may comprise a wired Ethernet router and/or an IEEE 802.11 (Wi-Fi) router, and may communicate with respective devices in or at premises 190 via wired and/or wireless connections. In this regard, it should be noted that various features of premises 190 may comprise “smart” appliances (e.g., network-connected devices/Internet of Things (IoT) devices), with wired and/or wireless networking/communication capability. Thus, such appliances may be remotely programmed or configured, and may communicate operational data to remote devices via one or more networks or network links. For instance, each of these devices may include a transceiver for IEEE 802.11-based communications, for IEEE 802.15-based communications, for wired communications, e.g., for wired Ethernet, and so forth. In one example, router 194 may be in further communication with one or more additional wireless access points, e.g., wireless access points (APs) 198 and 199, e.g., via wired and/or wireless (e.g., Wi-Fi) connections. For instance, the premises 190 and/or the home 191 may be configured with a wireless mesh network provided via router 194 and APs 198 and 199.

In one example, premises 190 may include a building management system (BMS) 195. In one example, BMS 195 may comprise a computing system, such as computing system 300 depicted in FIG. 3, and may be configured to provide one or more functions in connection with examples of the present disclosure for detecting that a non-approved endpoint device is within an alert perimeter associated with a premises via tracking of a movement in accordance with wireless signal data of the non-approved endpoint device contained in wireless environment data associated with at least one wireless network access point at the premises, such as illustrated in FIG. 2 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 3 and discussed below) or multiple computing devices collectively configured to perform various steps, functions, and/or operations in accordance with the present disclosure.

As illustrated in FIG. 1, BMS 195 may be in communication with various network-connected devices/appliances at premises 190. In this regard, BMS 195 may also include a transceiver for IEEE 802.11-based communications, for IEEE 802.15-based communications, for wired communications, e.g., for wired Ethernet, and so forth. It should be noted that as described herein, functions of BMS 195 may similarly be performed by server(s) 114, and vice versa. However, for illustrative purposes, examples are described primarily in connection with BMS 195.

In an illustrative example, an owner, occupant, property manager, etc. (e.g., user 140) may configure the premises 190 and/or home 191 to have a protected perimeter, e.g., the bounds of the property/premises 190 (or a lesser or greater coverage area, within the capabilities of BMS 195, router 194, and/or APs 198 and 199). In accordance with the present disclosure, the BMS 195 itself and/or via the wireless network (e.g., router 194, AP 198, and/or AP 199) may detect and monitor different wireless electronic devices within the environment. This may include devices within the perimeter associated with premises 190 and/or home 191, as well as devices that may be nearby, e.g., on the periphery, just outside the perimeter, but within the detection range of the BMS 195 and/or the wireless network. In one example, wireless electronic devices that are attached to the wireless network may be tracked and monitored. In this case, detailed information on the respective devices may be available, such as the media access control (MAC) address, the device type, a device name, and so forth. In addition, for devices that are attached to the network, as well as for devices that are within or near the perimeter but that are unattached to the wireless network of premises 190/home 191, the BMS 195 may track the locations/movement and/or other device behaviors.

To illustrate, BMS 195 may seek to identify and categorize all wireless electronic devices detectable by BMS 195 and/or the wireless network of premises 190/home 191. For devices that are within range to attach to the wireless network and that are previously known (e.g., device 110 of user 140, devices of family, friends, regular visitors (e.g., contractors, landscapers, etc.)), BMS 195 may identify and categorize these devices directly from network registration/attachment signaling procedures and ongoing communications via router 194 and/or APs 198 and 199. For devices that are not attached to the wireless network (e.g., either due to being too far to obtain a useable signal-to-noise ratio or because the device is not attempting to attach to the network), BMS 195 may perform wireless electronic sensing to identify such devices and/or to categorize such devices as being known, approved, not a threat, a potential threat, a known threat, etc.

For instance, using channel state information (CSI) wireless sensing or the like, BMS 195 may sense a device on the periphery of the coverage range of the wireless network of premises 190/home 191. For example, user 140 with device 110 may be approaching the user’s home 191. BMS 195 may create a record for this unknown device within a device database maintained by BMS 195. In one example, BMS 195 may track the movement of such device, e.g., using CSI wireless sensing. However, when the device 110 comes closer and/or enters the premises 190 and/or home 191, the device 110 may be sufficiently close to router 194, AP 198, and/or AP 199 to attach to/register with the wireless network. In this case, BMS 195 may determine that the initially unknown device is in fact a known device, device 110, of the homeowner 140. In this case, in one example BMS 195 may take no further action, or may copy the data from the record for the unknown device into an existing record for the device 110, and may delete the record for the unknown device.

On the other hand, using CSI wireless sensing or the like, BMS 195 may sense another device on the periphery of the coverage range of the wireless network of premises 190/home 191, such as device 112 of user 141. BMS 195 may create a record for this unknown device within a device database maintained by BMS 195. In one example, BMS 195 may track the movement of such device, e.g., using CSI wireless sensing. As noted above, no alert may be provided for devices that are outside a defined perimeter, e.g., the bounds of the premises 190 or the like. However, BMS 195 may determine that the unknown device, e.g., device 112, has crossed the boundary/perimeter and entered the premises 190. In one example, when the device 112 is unknown, an alert may be generated and transmitted to user 140, e.g., at device 110. The user 140 may then provide an instruction to approve, deny, continue to monitor, or the like, the detected device 112. For instance, the user 140 may be meeting with a contractor (e.g., user 141), may receive the alert, and may indicate that the device 112 (and hence user 141) is not a threat. The BMS 195 may apply this designation to the record, and may then continue to detect that device 112 is at or near the premises 190, but may suppress alerts/alarms because device 112 is now deemed to be a known device. In one example, user 140 may provide a time limit for the authorization/approval. Thus, for example, if device 112 returns to the premises 190 at another time, such as during overnight hours, device 112 may now be treated as non-approved/potential threat, or the like, and hence subject to be alerted to the user 140/device 110 upon detection within the perimeter of premises 190.

In another example, user 141 with device 112 may be a malicious actor, such as an intruder. In this case, device 112 may likewise be detected when approaching outside the perimeter of premises 190. Similar to the above, the movement of device 112 may be tracked and it may be detected that device 112 eventually crosses the perimeter of premises 190. In this case, an alert may also be transmitted to user 140 at device 110. However, the user 140 may be away from home, and the user 141/device 112 may be unexpected at the premises 190. In this case, the user 140 may provide an instruction to BMS 195 that the device 112 is unauthorized. In one example, BMS 195 may then implement one or more remedial actions, e.g., of its own election according to its configuration and/or as instructed by user 140 from device 110. For instance, camera 177 may be an indoor camera that is typically inactive, but which may be activated by BMS 195 in certain emergency situations, such as detecting a potential intruder. Similarly, smart speaker 179 may begin playing alarms/alerts that may be heard by those nearby, which may help to scare/deter the intruder, which may assist law enforcement in finding the correct premises 190/home 191, and so forth.

In another example, the user 140 may initially select to continue to monitor, in which case BMS 195 may not immediately implement any immediate remedial action. However, BMS 195 may continue to track the movement of device 112. In addition, BMS 195 may correlate device movement and/or other behavioral data with data/communications for other infrastructures, such as door 154, window 155, etc. Thus, for example, BMS 195 may determine that user 141 with device 112 may be lurking near window 155. Alternatively, or in addition, BMS 195 may determine that device 112 is proximate to the window 155 when the window 155 is opened. In one example, BMS 195 may be configured to automatically take action in certain situations. For instance, when an unknown device with a status of “monitor” is detected to be lurking near a window or to be associated with an opening of a window, camera 177 may automatically be turned on, a notification may be presented to user 140 at device 110 that may override a do-not-disturb setting, a focus setting, a theater mode setting, or the like, an alert may be transmitted to law enforcement or another monitoring entity, e.g., a home security service, and so forth.

In this regard, it should be noted that in one example, BMS 195 may include a categorization agent comprising one or more machine learning algorithms (MLAs), e.g., one or more trained machine learning models (MLMs). For instance, a machine learning algorithm (MLA), or machine learning model (MLM) trained via a MLA may be for detecting a device type, for categorizing an unknown device as a potential threat, benign, friendly, etc., and/or for other tasks in accordance with the present disclosure. For instance, the MLA (or the trained MLM) may comprise a deep learning neural network, or deep neural network (DNN), such as convolutional neural network (CNN), a generative adversarial network (GAN), a language model, or “large language model” (LLM) such as a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models, a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. In one example, the detection MLM(s) may be trained at a network-based processing system (e.g., server(s) 114, AS 104, or the like) and deployed to BMS 195. Alternatively, or in addition, BMS 195 may train and implement one or more of such models, and or may update such models via reinforcement learning (RL), ongoing observations and retraining, or the like.

To further illustrate, a MLM of the present disclosure may be trained to categorize an unknown wireless endpoint device as being a threat/potential threat, benign/friendly, etc. (e.g., a binary classifier and/or multi-class classifier). In one example, such an MLM may alternatively be trained to generate an output indicating a likelihood of being a threat, such as on a scale of 0-5, 1-10, 1-100, etc. In one example, a training data set may comprise labeled examples with a threat score and/or threat label for input data vectors comprising device movement information. In addition, in one example, such input data vectors may include other device behavioral information, such as electromagnetic signatures/patterns associated with each device, network activity data (e.g., times attached, volume of data sent/received, etc., whether the device attached or did not attach to the network, or the like), and so forth. Thus, for example, from channel state information (CSI) or the like, BMS 195 may extract device movement information as well as the electromagnetic patterns/activities associated with a device. This data set of device behavior may then be input to one or more MLMs as an input vector, where the one or more MLMs may be trained/configured to indicate a threat level as the output in response to the input vector.

In this regard, it should be noted that in some examples, BMC 195 may provide a recommended categorization of an unknown device to user 140 based upon the device behavioral data that is collected, tracked, and monitored. Alternatively, or in addition, BMC 195 may be configured to take automated actions, such as activating visual or audible alarms, contacting law enforcement and/or a home security service, interrupting the user 140 at device 110, alerting other individuals designated to receive alerts, such as a neighbor of user 140, other tenants or family members, etc. at their respective devices, and so forth. As noted above, in various examples, the alerts to user 140 or others may provide additional useful information, such as a likely device type (which may be detected via a MLM such as described above that is trained on training data set of device behavioral data vectors labeled with a device type of the associated device), a list of all devices on the network (for example, it may be useful to user 140 to known that a spouse and children are at home, and may simply be having friends over for a visit, etc.), a heatmap of device locations of the unknown device, and so forth. On the other hand, a homeowner, a building manager, an emergency responder, etc. may be better equipped to address the situation of a potential intruder with additional image data from camera 177, which may confirm the presence of an intruder for instance, or which may indicate that the home 191 appears to be empty (for instance, the window may have been simply broken by a baseball from children playing in a nearby yard or a bird strike).

As noted above, network-connected electronic devices at premises 190 and/or home 191 may be in communication with one another via peer-to-peer wireless links and/or via a wired or wireless local area network (LAN). In addition, these network-connected electronic devices may share notifications with each other regarding device statuses/conditions, actions taken, and so forth. Thus, one of the network-connected electronic devices may take actions and/or place itself in an operational state, change operational states, etc. based upon notifications from one or more other network-connected electronic devices. For instance, when the door 154 is opened, the door 154 may notify the camera 177. In addition, the BMS 195 may alert the camera 177 of an unknown device within the perimeter of premises 190. In one example, camera 177 may be configured, e.g., by user 140, to activate recording upon detecting these conditions. In other words, some of the devices at premises 190/home 191 may not take instructions directly from BMS 195 but may have independent decision-making logic to determine when to active and deactivate core functions, such as when to record, when to report/stream video, and so forth.

In one example, network-connected electronic devices such as camera 177 and smart speaker 179 may report their actions to BMS 195 and/or server(s) 114, which may be recorded in an action log (which may also record the actions of BMS 195 itself). In one example, a responsible user, such as user 140, may access the action log and may determine whether any instances of such automated actions were incorrect (e.g., not preferred by the user 140). For instance, user 140 may utilize a user interface to view and select one or more entries in the action log, and may provide an input to indicate that these actions were incorrect. Thereafter, BMS 195 may reconfigure itself, such as via retraining one or more MLMs, adjusting rule triggers for whether and when to generate alerts, etc. and/or may send instructions to one or more other devices, such as camera 177 to alter the respective configuration(s).

In addition, in one example, nearby premises may share information and coordinate with one another with respect to identifying and classifying wireless endpoint devices. For instance, a neighbor using a known device at a neighboring property, e.g., premises 180, may clearly be identified as a non-threat at the neighbor’s wireless network. If this type of information is shared with premises 190/home 191 (e.g., BMS 195 thereof), then non-threat devices may be more easily identified, and focus can be applied to those unknown devices that are not yet categorized as a threat or not. However, if premises 180 can share information that endpoint device 112 is already labeled as a threat/potential threat, then when device 112 approaches premises 190, BMS 195 may more quickly determine that it may be the same device indicated by premises 180, and may treat it as a threat. For instance, BMS 195 may immediate treat device 112 as a known threat without asking user 140 and without waiting for an answer. In one example, this may be determined based upon a wireless usage profile. In other words, BMS 195 may not wait to observe movements of device 112, but may detect a similarity of the electromagnetic/wireless usage to the profile of device 112 that may be shared by premises 180. Upon a match, it may be identified as the same device and may immediately be treated as a threat. In still another example, premises 180 and 190 may more closely coordinate, and the movement of device 112 may be seamlessly tracked from premises 180 to premises 190, e.g., with both premises sharing the respective detected locations/movement in real time (which should match up when device 112 is within detection range of the wireless networks of both premises).

It should be noted that the foregoing are just several examples of the present disclosure for detecting that a non-approved endpoint device is within an alert perimeter associated with a premises via tracking of a movement in accordance with wireless signal data of the non-approved endpoint device contained in wireless environment data associated with at least one wireless network access point at the premises. Thus, it should be noted that in other, further, and different examples, aspects described above with respect to BMS 195 may alternatively or additionally be provided by server(s) 114 and/or AS 104, and vice versa. For example, server(s) 114 may collect device behavior data from different premises, and may train one or more MLMs to categorize/classify different threat levels. Alternatively, or in addition, server(s) 114 may collect channel state information (CSI) from different premises and may train one or more MLMs to detect device types of various devices from the CSI. In one example, server(s) 114 may be deployed at a network edge, e.g., an edge cloud, such as one of access network(s) 122, and may perform the same or similar operations as described above with respect to BMS 195. For instance, device behavioral data may be collected via router 194 and/or BMS 195, etc. and streamed to server(s) 114, where server(s) 114 may process the data as new inputs, e.g., to one or more MLMs for real-time/live threat detection/categorization, for providing alerts to the user 140, and so forth. Likewise, although BMS 195 is illustrated as a separate component from router 194, in one example BMS 195 may comprise additional functionality and/or may be a component of router 194. In another example, BMS 195 may be omitted, and the router 194 may stream CSI information to server(s) 114 and/or AS 104. In addition, although FIG. 1 is illustrated and described in connection with an example of a user’s home, the present disclosure is broadly applicable to various other types of locations, such as an office building, an apartment building, a mixed-use building, a campus, a campsite, a public space (which can be indoor or outdoor), a vehicle, such as a ship, a bus, and so on.

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. In addition, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. For example, server(s) 114 and gateway 192 may reach network 102 via different access networks, and so forth. Thus, these and other modifications are all contemplated within the scope of the present disclosure.

FIG. 2 illustrates a flowchart of an example method 200 for detecting that a non-approved endpoint device is within an alert perimeter associated with a premises via tracking of a movement in accordance with wireless signal data of the non-approved endpoint device contained in wireless environment data associated with at least one wireless network access point at the premises. In one example, the method 200 is performed by BMS, a server, and/or an application server, such as illustrated in FIG. 1, or the like, or any one or more components thereof, or by any one or more of such devices in conjunction with one another and/or in conjunction with other devices and/or components of system 100 of FIG. 1, such as camera 177, device 110, etc. In one example, the steps, functions, or operations of method 200 may be performed by a computing device or processing system, such as computing system 300 and/or hardware processor element 302 as described in connection with FIG. 3 below. For instance, the computing system 300 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 300 may collectively function as a processing system. For illustrative purposes, the method 200 is described in greater detail below in connection with an example performed by a processing system. The method 200 begins in step 205 and may proceed to optional step 210 or to step 220.

At optional step 210, the processing system may track past movement of a first non-approved endpoint device in accordance with historical wireless signal data of the first non-approved endpoint device in historical wireless environment data associated with at least one wireless network access point at a premises. It should also be noted that although the terms, “first,” “second,” “third,” etc., are used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not necessarily imply a particular number of those items corresponding to those numerical values. In addition, the use of the term “third” for example, does not imply a specific sequence or temporal relationship with respect to a “first” and/or a “second” of a particular type of item, unless otherwise indicated.

At optional step 215, the processing system may generate a first device behavior profile from at least the past movement. For instance, such a device profile may include information indicating locations at the premises where the detected device spends the most time, the times of day that the device is detected to be present, whether the device is attached to the wireless network, a data volume, the protocol(s) used by the device, the frequencies used and/or other electromagnetic signature/profile information, and so forth. In one example, the behavior profile may be updated for multiple instances of the presence at or near the property. For instance, the behavior profile may account for the way in which a landscaper navigates the premises over several months of weekly visits and/or to further account for the way in which the endpoint device communicates in the wireless environment. In one example, the data of the first device behavior profile may be vectorized for subsequent use, such as at optional step 250.

At step 220, the processing system obtains first wireless environment data associated with the at least one wireless network access point at the premises. For instance, the first wireless environment data may include channel state information (CSI) detected via the at least one wireless access point and/or via another wireless sensing device, such as wireless-equipped BMS, or the like.

At step 225, the processing system detects that the first wireless environment data includes first wireless signal data of the first non-approved endpoint device. For instance, the processing system may analyze the wireless environment data, e.g., CSI data, to identify different devices in the wireless environment. The devices may include known devices which may voluntarily share location information with the processing system. As such, the processing system may determine that some unique devices having wireless signals present in the CSI are the one or more known devices, where location(s) determined from the CSI may be matched to voluntarily reported location information. Other devices that are not known and which do not voluntarily report location(s) may be labeled as unknown, threat/potential threat, or the like. In one example, the first non-approved endpoint device may be detected for the first time via the first wireless signals in the first wireless environment data. In another example, the first non-approved endpoint device may have been previously detected in accordance with the historical wireless signal data of the first non-approved endpoint device in the historical wireless environment data associated with the at least one wireless network access point at the premises, such as in accordance with optional step 210.

At step 230, the processing system tracks a movement of the first non-approved endpoint device in accordance with the first wireless signal data of the first non-approved endpoint device in the first wireless environment data. For instance, the tracking of the movement may include: tracking positions of the first non-approved endpoint device in accordance with the first wireless signal data via at least one of: time of flight measurements, fine timing measurement ranging, channel state information (CSI) wireless sensing, or the like. In one example, one or more techniques may be used depending upon whether the first non-approved endpoint device attaches to the wireless network or not. For instance, the processing system may perform round-trip time-of-flight measurements when the device is attached to the network. Alternatively, or in addition, in some cases a non-approved endpoint device may voluntarily report its location (which may influence a determination of whether or not such endpoint device is or is not a threat).

At step 235, the processing system detects, via the tracking of the movement of the first non-approved endpoint device in accordance with the first wireless signal data that the first non-approved endpoint device is within an alert perimeter associated with the premises. For instance, the alert perimeter may define an area that is within a detection range of the first wireless environment data (e.g., the perimeter defines a protected area that is smaller than, and that resides within the detection range). It should be noted that different ranges may exist for different frequencies. In addition, the range(s) may be defined by different signal strength and/or noise floor thresholds, for instance.

At optional step 240, the processing system may detect a device type of the first non-approved endpoint device based upon the first wireless signal data of the first non-approved endpoint device. For instance, in one example, the device type may be detected via a machine learning model implemented by the processing system that is trained to detect the device type based upon a training data set of wireless signal data of a plurality of devices of a same device type. To further illustrate, a second device behavior profile may be based upon wireless signal data of a plurality of devices of a same device type associated with at least one of: the at least one wireless network access point at the premises, or one or more proximate wireless network access points associated with one or more different wireless communication networks (e.g., including past movements of the other devices and/or the wireless signal usage, the spectrum profile(s), etc.).

At optional step 245, the processing system may determine a first device behavior from at least the movement of the first non-approved endpoint device in accordance with the first wireless signal data. For instance, the first device behavior may include the movement history, one or more locations from the movement history, a time spent at different locations within or near the premises, etc. In one example, the first device behavior may further include indications of whether the device is attached to the wireless network, a data volume, the protocol(s) used by the device, the frequencies used and/or other electromagnetic signature/profile information, and so forth. In one example, the data of the first device behavior may be vectorized for subsequent use, such as at optional step 250.

At optional step 250, the processing system may determine that the first device behavior deviates from a first device behavior profile and/or from a second device behavior profile. For instance, the first device behavior profile may be based upon a past movement of the first non-approved endpoint device that is tracked in accordance with historical wireless signal data of the first non-approved endpoint device in historical wireless environment data associated with the at least one wireless network access point at the premises. For instance, such a profile may be generated at optional step 215. On the other hand, the second device behavior profile may be based upon wireless signal data of a plurality of devices of a same device type associated with at least one of: the at least one wireless network access point at the premises, or one or more proximate wireless network access points associated with one or more different wireless communication networks. In one example, the determining of the deviation(s) may be via one or more machine learning models that is/are configured to determine whether the behavior is out of range (e.g., indicative of a potential threat). For instance, in one example, a vector representing the first device behavior may be compared to a vector representing the first device behavior profile, e.g., in an N-dimensional feature space. A distance metric (e.g. a distance threshold) between the vectors may define whether there is a deviation or not (e.g., a distance over the threshold may indicate a deviation). Alternatively, or in addition, a different type of MLM such a decision tree, a CNN, etc., may represent a classifier to define whether the first device behavior matches the first device behavior profile. In one example, an MLM may be configured to process an input vector comprising: (a) the first device behavior and (b) the first device behavior profile, to determine whether there is a match/agreement or a deviation. In another example, such a MLM may be particularized for a given endpoint device, in which case the input vector may comprise only the first device behavior. It should be noted that a similar MLM may represent the second device behavior profile that is configured to use an input vector comprising: (a) the first device behavior and (b) the second device behavior profile, or in some cases just the first device behavior. In one example, the deviations may be indicative of a threat/potential threat, e.g., an intruder at the premises. In one example, the distance(s) and/or score(s) described above may indicate the likelihood that the first non-approved endpoint device is a threat. In another example, an additional MLM or scoring model may be used to combine these factors to indicate a threat level.

At step 255, the processing system generates a first alert in response to the detecting that the first non-approved endpoint device is within the alert perimeter associated with the premises. In one example, the first alert may be generated further in accordance with the first device behavior profile of the first non-approved endpoint device as mentioned above at optional step 250. For instance, in one example, the non-approved endpoint device may have been approved in the past, but the approval may have expired. Hence, the processing system may look at the normal behaviors of the device in the past, e.g., in accordance with optional steps 210 and 215. In one example, when the device is detected at a later time while having a status of non-approved, the processing system may suppress an alert if the behavior is within normal range. For instance, a property manager may have forgotten to indicate that a landscaper would be coming on Wednesday instead of Friday when the landscaper typically visits the premises. In these types of situations, the property manager may configure the processing system to only escalate alerts when the processing system detects a non-approved endpoint device breaching the perimeter and exhibiting additional, behavior indicative of a threat/potential threat. In one example, the first alert may be generated further in accordance with the second device behavior profile associated with the device type of the first non-approved endpoint device, such as in accordance with the detecting of the device type at optional step 240 and the determining of the deviation from the second device behavior profile at optional step 250. For example, if behaviors of the first non-approved endpoint device (e.g., electromagnetic signature, usage of the wireless network, etc.) deviate from what is “normal” for other devices of a same type, this may be further indicative that the first non-approved endpoint device is a threat (or conversely, where devices of the same device type are known to be used by malicious actors and the behavior is typical of such device type, this may also be indicative of a threat/potential threat).

In one example, step 255 may include transmitting the first alert to an endpoint device comprising a user application associated with the at least one wireless network access point (e.g., to a device of a property owner, manager, tenant, etc.). Alternatively or in addition, the generating of the alert may include presenting a visual indicator, such as a light on the at least one wireless network access point or another nearby device that may not necessarily be the endpoint device of the user (such as a smart appliance, a traditional home alarm system, etc.). In still another example, the generating of the alert may also include transmitting instructions (e.g., an alert) for deploying an uncrewed aerial vehicle (UAV) or the like to a particular location on the premises/within the perimeter, such as to record video, shine a light on the location of the first non-approved endpoint device, etc.

At optional step 260, the processing system may present a list of detected wireless electronic devices including at least the first non-approved endpoint device, wherein the list includes for each detected wireless electronic device: a device identifier, device location information, and a device status. For instance, the location information may include a position relative to the at least one wireless access point, a position on a map of the premises, coordinates, e.g., latitude and longitude (and in some cases elevation), etc. In another example, the location may instead be “detected/outside perimeter” or “detected/inside perimeter.” In one example, optional step 260 may alternatively or additionally include presenting a map of detected wireless electronic devices, where the detected wireless electronic devices include at least the first non-approved endpoint device.

Following step 255 or optional step 260, the method 200 may proceed to step 295. At step 295 the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 220-255 or steps 220-260 for one or more additional non-approved endpoint devices, for a same non-approved endpoint device at a subsequent visit/detection, etc. In one example, steps 240-250 may precede step 235. In one example, the method 200 may further include collecting one or more training data sets from at least one of: the at least one wireless network access point, or one or more proximate wireless network access points associated with one or more different wireless communication networks, and training one or more machine learning models as described above using the training data set(s).

In one example, the method 200 may further include detecting that the first wireless environment data includes second wireless signal data of a first approved endpoint device, tracking a movement of the first approved endpoint device in accordance with the second wireless signal data of the first approved endpoint device in the first wireless environment data, and detecting, via the tracking of the movement of the first approved endpoint device in accordance with the second wireless signal data, that the first approved endpoint device is within the alert perimeter associated with the premises. In such an example, the method 200 may further include determining a second device behavior from at least the movement of the first approved endpoint device in accordance with the second wireless signal data, determining that the second device behavior deviates from a second device behavior profile, and generating a second alert in response to the detecting that the first approved endpoint device is within the alert perimeter associated with the premises and in response to the determining that the second device behavior deviates from the second device behavior profile. In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 3 depicts a high-level block diagram of a computing system 300 (e.g., a computing device or processing system) specifically programmed to perform the functions described herein. For example, any one or more components or devices illustrated in FIG. 1, or described in connection with FIG. 2, may be implemented as the computing system 300. As depicted in FIG. 3, the computing system 300 comprises a hardware processor element 302 (e.g., comprising one or more hardware processors, which may include one or more microprocessor(s), one or more central processing units (CPUs), and/or the like, where the hardware processor element 302 may also represent one example of a “processing system” as referred to herein), a memory 304, (e.g., random access memory (RAM), read only memory (ROM), a disk drive, an optical drive, a magnetic drive, and/or a Universal Serial Bus (USB) drive), a module 305 for detecting that a non-approved endpoint device is within an alert perimeter associated with a premises via tracking of a movement in accordance with wireless signal data of the non-approved endpoint device contained in wireless environment data associated with at least one wireless network access point at the premises, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 302 is shown, the computing system 300 may employ a plurality of hardware processor elements. Furthermore, although only one computing device is shown in FIG. 3, if the method(s) as discussed above is implemented in a distributed or parallel manner for a particular illustrative example, e.g., the steps of the above method(s) or the entire method(s) are implemented across multiple or parallel computing devices, then the computing system 300 of FIG. 3 may represent each of those multiple or parallel computing devices. Furthermore, one or more hardware processor elements (e.g., hardware processor element 302) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 302 can also be configured or programmed to cause other devices to perform one or more operations as discussed above. In other words, the hardware processor element 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 305 for detecting that a non-approved endpoint device is within an alert perimeter associated with a premises via tracking of a movement in accordance with wireless signal data of the non-approved endpoint device contained in wireless environment data associated with at least one wireless network access point at the premises (e.g., a software program comprising computer-executable instructions) can be loaded into memory 304 and executed by hardware processor element 302 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 302) executing the computer-readable instructions relating to the above described method(s) can be perceived as a programmed processor or a specialized processor. As such, the present module 305 for detecting that a non-approved endpoint device is within an alert perimeter associated with a premises via tracking of a movement in accordance with wireless signal data of the non-approved endpoint device contained in wireless environment data associated with at least one wireless network access point at the premises (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, first wireless environment data associated with at least one wireless network access point at a premises;
detecting, by the processing system, that the first wireless environment data includes first wireless signal data of a first non-approved endpoint device;
tracking, by the processing system, a movement of the first non-approved endpoint device in accordance with the first wireless signal data of the first non-approved endpoint device in the first wireless environment data;
detecting, by the processing system via the tracking of the movement of the first non-approved endpoint device in accordance with the first wireless signal data, that the first non-approved endpoint device is within an alert perimeter associated with the premises; and
generating, by the processing system, a first alert in response to the detecting that the first non-approved endpoint device is within the alert perimeter associated with the premises.

2. The method of claim 1, wherein the first non-approved endpoint device is detected for a first time via the first wireless signal data in the first wireless environment data.

3. The method of claim 1, wherein the first non-approved endpoint device has been previously detected in accordance with historical wireless signal data of the first non-approved endpoint device in historical wireless environment data associated with the at least one wireless network access point at the premises.

4. The method of claim 1, further comprising:
presenting a list of detected wireless electronic devices including at least the first non-approved endpoint device, wherein the list includes for each detected wireless electronic device: a device identifier, device location information, and a device status.

5. The method of claim 4, further comprising:
presenting a map of the list of detected wireless electronic devices, wherein the list of the detected wireless electronic devices includes at least the first non-approved endpoint device.

6. The method of claim 1, wherein the first alert is generated further in accordance with a first device behavior profile of the first non-approved endpoint device.

7. The method of claim 6, wherein the first device behavior profile is based upon a past movement of the first non-approved endpoint device that is tracked in accordance with historical wireless signal data of the first non-approved endpoint device in historical wireless environment data associated with the at least one wireless network access point at the premises.

8. The method of claim 7, further comprising:
tracking the past movement of the first non-approved endpoint device in accordance with the historical wireless signal data of the first non-approved endpoint device in the historical wireless environment data; and
generating the first device behavior profile from at least the past movement.

9. The method of claim 7, further comprising:
determining a first device behavior from at least the movement of the first non-approved endpoint device in accordance with the historical wireless signal data; and
determining that the first device behavior deviates from the first device behavior profile.

10. The method of claim 9, wherein the first alert is generated when it is determined that the first device behavior deviates from the first device behavior profile.

11. The method of claim 1, wherein the first alert is generated further in accordance with a second device behavior profile associated with a device type of the first non-approved endpoint device.

12. The method of claim 11, further comprising:
detecting the device type of the first non-approved endpoint device based upon the first wireless signal data of the first non-approved endpoint device.

13. The method of claim 12, wherein the device type is detected via a machine learning model implemented by the processing system that is trained to detect the device type based upon a training data set of wireless signal data of a plurality of devices of a same device type.

14. The method of claim 11, wherein the second device behavior profile is based upon wireless signal data of a plurality of devices of a same device type associated with at least one of: the at least one wireless network access point at the premises, or one or more proximate wireless network access points associated with one or more different wireless communication networks.

15. The method of claim 14, further comprising:
determining a first device behavior from at least the movement of the first non-approved endpoint device in accordance with the historical wireless signal data; and
determining that the first device behavior deviates from the second device behavior profile, wherein the first alert is generated when it is determined that the first device behavior deviates from the second device behavior profile.

16. The method of claim 1, wherein the generating of the first alert includes transmitting the first alert to an endpoint device comprising a user application associated with the at least one wireless network access point.

17. The method of claim 1, wherein the alert perimeter defines an area that is within a detection range of the first wireless environment data.

18. The method of claim 1, wherein the tracking of the movement of the first non-approved endpoint device in accordance with the first wireless signal data of the first non-approved endpoint device in the first wireless environment data comprises:
tracking positions of the first non-approved endpoint device in accordance with the first wireless signal data via at least one of:
time of flight measurements;
fine timing measurement ranging; or
channel state information wireless sensing.

19. A non-transitory computer-readable medium storing instructions that, when executed by a processing system including at least one processor, cause the processing system to perform operations, the operations comprising:
obtaining first wireless environment data associated with at least one wireless network access point at a premises;
detecting that the first wireless environment data includes first wireless signal data of a first non-approved endpoint device;
tracking a movement of the first non-approved endpoint device in accordance with the first wireless signal data of the first non-approved endpoint device in the first wireless environment data;
detecting, via the tracking of the movement of the first non-approved endpoint device in accordance with the first wireless signal data, that the first non-approved endpoint device is within an alert perimeter associated with the premises; and
generating a first alert in response to the detecting that the first non-approved endpoint device is within the alert perimeter associated with the premises.

20. An apparatus, comprising:
at least one processor; and
a non-transitory computer-readable medium storing instructions that, when executed by the at least one processor, cause the at least one processor to perform operations, the operations comprising:
obtaining first wireless environment data associated with at least one wireless network access point at a premises;
detecting that the first wireless environment data includes first wireless signal data of a first non-approved endpoint device;
tracking a movement of the first non-approved endpoint device in accordance with the first wireless signal data of the first non-approved endpoint device in the first wireless environment data;
detecting, via the tracking of the movement of the first non-approved endpoint device in accordance with the first wireless signal data, that the first non-approved endpoint device is within an alert perimeter associated with the premises; and
generating a first alert in response to the detecting that the first non-approved endpoint device is within the alert perimeter associated with the premises.
